(19) United States
(12) Patent Application Publication
(10) Pub. No.: US 2022/0310321 A1
(43) Pub. Date: Sep. 29, 2022

(54) METHOD OF MANUFACTURING AN ENCAPSULATED ELECTROMAGNETIC COIL WITH AN INTENTIONALLY ENGINEERED HEAT FLOW PATH

(71) Applicant: HONEYWELL INTERNATIONAL INC., Charlotte, NC (US)

(72) Inventors: Eric Passman, Morris Plains, NJ (US); Mahdi Mohajeri, Morris Plains, NJ (US); Bahram Jadidian, Morris Plains, NJ (US)

(73) Assignee: HONEYWELL INTERNATIONAL INC., Charlotte, NC (US)

(21) Appl. No.: 17/213,498

(22) Filed: Mar. 26, 2021

(51) Int. Cl. H01F 41/12; H02K 5/08; H02K 15/12

(52) U.S. Cl. CPC H01F 41/127; H02K 5/08; H02K 15/12

(57) ABSTRACT

A method for manufacturing an electromagnetic coil with an intentionally engineered heat flow path is provided. The method includes defining at least one preferential heat flow path for heat to flow from the electromagnetic coil. A plurality of different materials are selected, each having different heat flow properties. A determination is made as to which portions of the electromagnetic coil should be coated with each of the different materials that will result in the at least one preferential heat flow path. The determined portions of the electromagnetic coil are then coated with each of the different materials to make a coated electromagnetic coil, and the coated electromagnetic coil is encased in a coil cartridge.

### TECHNICAL FIELD

The present invention generally relates to encapsulated electromagnetic coils, and more particularly relates to a method of manufacturing an encapsulated coil with an intentionally engineered heat flow path for extreme operating conditions.

### BACKGROUND

Electric motors are used in a myriad of systems and environments. They can generate relatively large amounts of heat during powered operation. More specifically, during motor operation, current flow through the electromagnetic coils causes heat to be generated due, in part, to the resistance of the coils. This heat causes the coil and device temperatures to rise. As the coil temperatures increases, the generated heat is typically transferred from the coils toward area(s) with lower temperatures. The higher the temperature the coils and motor assembly can handle, the higher the power density of the motor.

As may be appreciated, the heat that is generated in, and transferred away from, the electromagnetic coils, can increase the temperatures of various other components to undesirable levels. As such, the operational temperature of most conventional electromagnetic coils is limited to less than 250° C. for devices making use of polyamide wire electrical insulation. This consequently imposes limits on the applied current and/or electrical potential to the electromagnetic coils, as well as the ambient conditions surrounding the motor. This, in turn, limits the achievable power density, and potential operating environments, of the motor (or other electromagnetic device).

Using a wire electrical insulation coating capable of temperatures greater than 250° C. in conjunction with improving the thermal management of electromagnetic devices, such as electric motors, has the potential to dramatically reduce overall size and improve overall efficiency while further improving the power density. The efficiency improvements can be realized by reducing the additional power draw and/or system complexity required for cooling system add-ons to keep the electromagnetic device cool. The ability to operate the electromagnetic device with increased power input and/or at higher temperature would also increase power density.

Hence, there is a need for a method of improving the overall temperature capability via improved thermal management of electromagnetic devices. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a method for manufacturing an electromagnetic coil with an intentionally engineered heat flow path includes defining at least one preferential heat flow path for heat to flow for the electromagnetic coil. A plurality of different materials are selected, each having different heat flow properties. A determination is made as to which portions of the electromagnetic coil should be coated with each of the different materials that will result in the at least one preferential heat flow path. The determined portions of the electromagnetic coil are then coated with each of the different materials to make a coated electromagnetic coil, and the coated electromagnetic coil is encased in a coil cartridge.

In another embodiment, a method for manufacturing an electromagnetic coil with an intentionally engineered heat flow path includes defining at least one preferential heat flow path for heat to flow for the electromagnetic coil. A plurality of different materials are selected, wherein the plurality of different materials includes at least a first material having first heat flow properties and a second material having second heat flow properties that are different than the first heat flow properties. A determination is made as to which portions of a coil cartridge should be made from at least the first material and the second material that will result in the at least one preferential heat flow path. The electromagnetic coil is encased in the coil cartridge using at least the first and second materials.

In yet another embodiment, a method for manufacturing an electromagnetic coil with an intentionally engineered heat flow path includes defining at least one preferential heat flow path for heat to flow from the electromagnetic coil. A plurality of different materials are selected, having different heat flow properties. A determination is made as to which portions of a coil cartridge should be coated with each of the different materials that will result in the at least one preferential heat flow path. The electromagnetic coil is encased in the coil cartridge, and the determined portions of the coil cartridge are coated with at least some of the different materials.

Furthermore, other desirable features and characteristics of the electromagnetic coil manufacturing method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified schematic cross-sectional view of one embodiment of a motor;

FIG. 2 depicts a simplified schematic cross-sectional view of one embodiment of an encased coil cartridge that may be used in the motor of FIG. 1;

FIG. 3 depicts one process, in flowchart form, that may be used to manufacture the encased electromagnetic coil of FIG. 2;

FIG. 4 depicts a representative graph of thermal conductivity versus temperature for various materials;

FIG. 5 depicts a simplified schematic cross-sectional view of one embodiment of an encased electromagnetic coil that comprises multiple materials of differing heat flow properties and that is coated with multiple materials of different heat flow properties; and

FIG. 6 depicts another process, in flowchart form, that may be used to manufacture the encased electromagnetic coil of FIG. 5.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the phrase “heat flow property(ies)” encompasses both thermal conductivity and thermal diffusivity. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

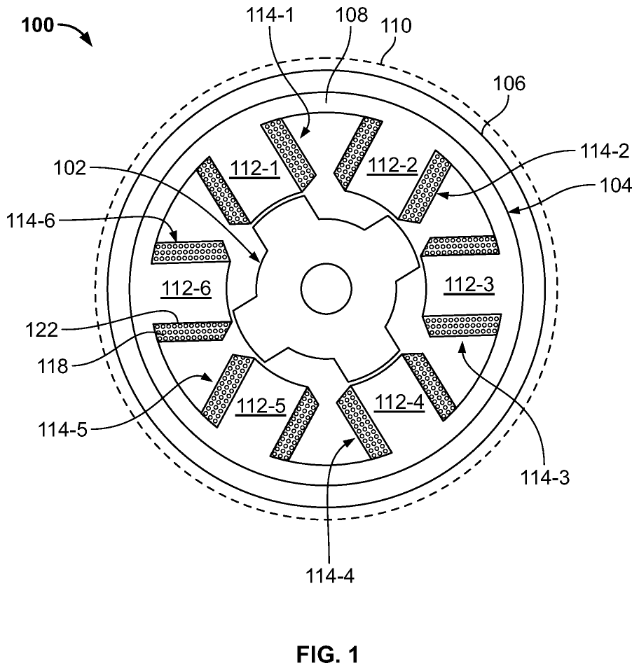

Referring first to FIG. 1, a simplified schematic cross-sectional view of one embodiment of a motor 100 is depicted. The motor 100 includes a rotor 102 and a stator 104. The rotor 102 is mounted for rotation and is configured, upon receiving a drive torque, to rotate relative to the stator 104. The stator 104 at least partially surrounds the rotor 102 and includes at least a stator housing 106, a stator structure 108, which includes a plurality of spaced-apart stator poles 112 (112-1, 112-2, 112-3, . . . 112-6), and a plurality of encased electromagnetic coils 114 (114-1, 114-2, 114-2, . . . 114-6). Before proceeding further, it is noted that although the depicted motor 100 is configured as a switched reluctance motor, it will be appreciated that the techniques described herein apply to numerous other motor configurations and to numerous other types of electromagnetic devices.

Returning to the description, it is seen that the stator structure 108 is disposed within the stator housing 106 via, for example, a shrink fit or a press fit, and has a plurality of end bells 110 coupled thereto. For clarity and ease of depiction, only one end bell 110 is depicted and is done so using dotted lines. In the depicted embodiment, each of the stator poles 112 is attached to a back-iron and extends radially inwardly toward the rotor 102. It will be appreciated, however, that in other embodiments each of the stator poles 112 may be joined to a ring at the inner diameter of the stator structure 108 and extend radially outwardly.

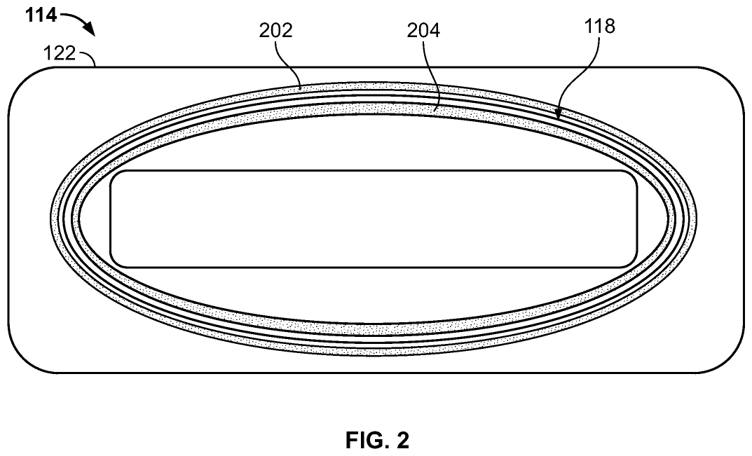

In the depicted embodiment, each of the encased electromagnetic coils 114 is disposed around a different one of the stator poles 112. Each encased electromagnetic coil includes an electromagnetic coil 118 that is encased in a coil cartridge 122. For completeness, a simplified cross-sectional plan view of one embodiment of an encased electromagnetic coil 114 is depicted in FIG. 2. It should be noted that although the electromagnetic coil 118 depicted in FIG. 2 (and in other figures) has a generally symmetric, elliptical shape, this is shape is only exemplary of one embodiment. In other embodiments, the electromagnetic coil 118 may be formed into various shapes, both symmetric and non-symmetric, as needed or desired to establish a preferential heat flow path, as will now be described.

Regardless of its specific shape, and as FIG. 2 depicts, the insulated electromagnetic coil 118 has a plurality of different materials coated thereon. In the embodiment depicted in FIG. 2, this includes a first material 202 and a second material 204. However, as will be described further below, it will be appreciated that in other embodiments the number of different materials may be more or less than two.

Regardless of the number and type of materials that are coated on the coils 118, doing so results in each of the encased electromagnetic coils 114 exhibiting an intentionally engineered heat flow path such that heat that is generated in the electromagnetic coil 118 flows from the electromagnetic coil 118 along at least one preferential heat flow path. For the motor 100 depicted in FIG. 1, the at least one preferential heat flow path may be one or more of an axially directed heat flow path toward the end bells 110, a radially directed heat flow path toward or away from the stator housing 106, an inwardly directed heat flow path toward the stator pole 112 around which the encased electromagnetic coil 114 is disposed, and an outwardly directed heat flow path toward an adjacent encased electromagnetic coil 114.

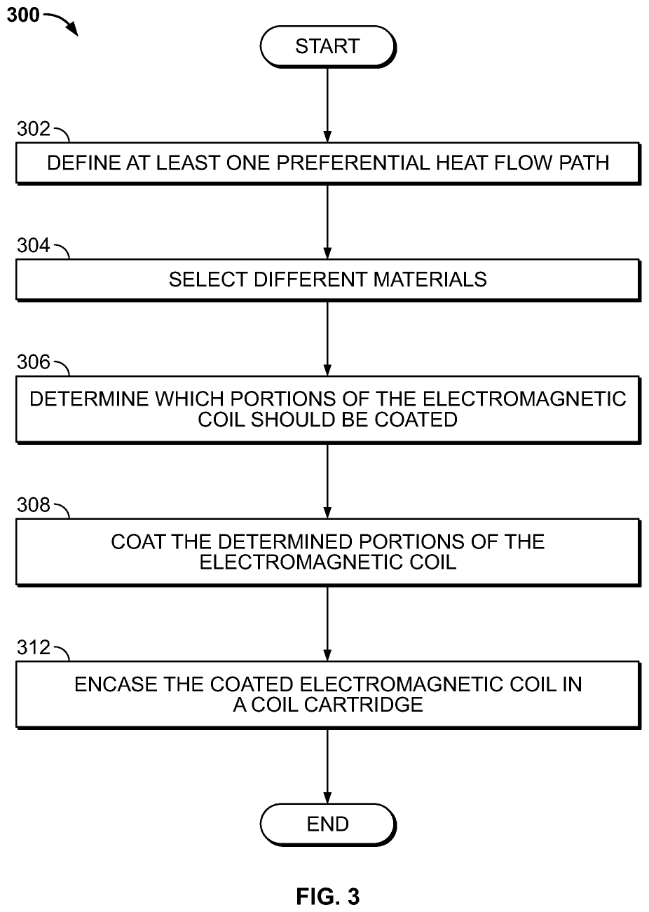

One method by which each encased electromagnetic coil 114 is manufactured to exhibit the intentionally engineered heat flow path will now be described. In doing so, reference should be made to FIG. 3, which depicts the general process 300 in flowchart form. Moreover, the parenthetical numeric references in the following description refer to like-numbered process symbols in the flowchart. Before describing the process in detail, it should also be noted that the heat generated in the electromagnetic coil 118 will be defined in advance using conventional thermal analysis and modeling, which is related to power density, length, number of turns, and material. Moreover, because the electromagnetic coil 118 exhibits relatively high heat flow properties it is assumed that the temperature thereof will be uniform.

With the above in mind, and as FIG. 3 depicts, the process 300 begins by defining at least one preferential heat flow path for heat to flow from the electromagnetic coil 118 (302). A plurality of different materials, each having different heat flow properties, is then selected (304). A determination is then made as to which portions of the electromagnetic coil 118 should be coated with each of the different materials that will result in the at least one preferential heat flow path (306). The determined portions of the electromagnetic coil 118 are then coated with each of the different materials to make a coated electromagnetic coil 118 (308). The coated electromagnetic coil 118 is then encased in the coil cartridge 122 (312) to produce an encased electromagnetic coil 114.

It will be appreciated that the number and type of the different materials may vary. For example, the plurality of different materials may include one or more of a glass, a ceramic, a metallic, a polymeric, or a composite thereof. Some specific examples of suitable materials include, but are not limited to, zirconia, silicon nitride, nickel-molybdenum alloy, stainless steel, various low-carbon steels, silicon carbide, silver, copper gold, aluminum, tungsten, platinum, iron, aluminum oxide, ceramic glass (such as Pyroceram®), fused quartz, various glasses, cements, silicates phosphates, magnesium oxide, zircon, various composites, and aerogels, just to name a few. In some embodiments, one or more of the different materials may comprise a fabric having one or more of these materials embedded therein. It will additionally be appreciated that the particular characteristics of each of the different materials may vary. For example, the thermal conductivity of each of the different materials may be in the range of 0.01 W/m-K to 2000 W/m-K, and more preferably in the range of 0.25 W/m-K to 50 W/m-K. Moreover, the thermal diffusivity of each of the different materials may be in the range of 1×10⁻⁸ m²/sec to 0.01 m²/sec.

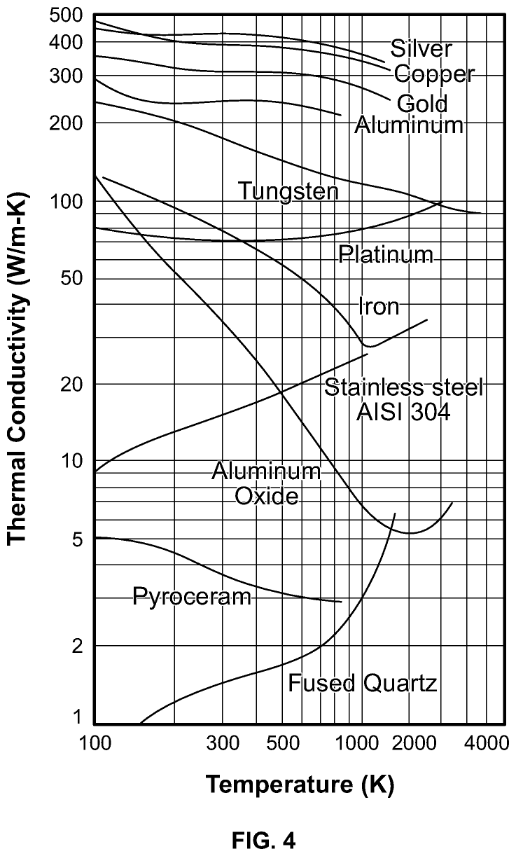

In some embodiments, instead of coating portions of the electromagnetic coil 118, at least portions of the coated electromagnetic coil 118 itself may be embedded with a material having predetermined heat flow properties. Moreover, in some embodiments, one or more of the materials may have heat flow properties that vary at different rates with temperature. Indeed, FIG. 4 depicts a representative graph 400 of thermal conductivity versus temperature for various ones of the above-mentioned materials. With this in mind, it will be appreciated that the plurality of different materials may be selected, and the portions of the electromagnetic coil 118 may be determined, such that the at least one preferential heat flow path varies at one or more predetermined temperatures.

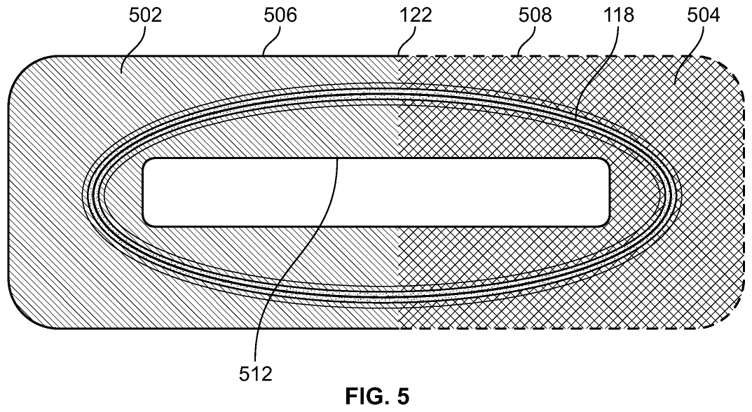

In addition to or instead of coating different portions the electromagnetic coil 118, the coil cartridge 122 may be designed to comprise a plurality of different materials, each having different heat flow properties. For example, in the simplified embodiment depicted in FIG. 5, the coil cartridge is comprised of a first material 502 having first heat flow properties and a second material 504 having second heat flow properties that differ from the first heat flow properties.

Moreover, in addition to or instead of the making the coil cartridge of different materials, different portions of the coil cartridge 122 may be coated with a plurality of different coating materials, each having different heat flow properties. Again, in the simplified embodiment depicted in FIG. 5, the coil cartridge is coated with a first coating material 506 having first heat flow properties, a second coating material 508 having second heat flow properties that differ from the first heat flow properties, and a third coating material 512 having third heat flow properties that differ from the first and second thermal heat flow properties. In other embodiments, the heat flow properties of the third coating material 512 may be the same as the first or second coating materials, or it may comprise two different materials, with one having the same heat flow properties as the first material, and the other having the same heat flow properties as the second material, just to name a couple of variations.

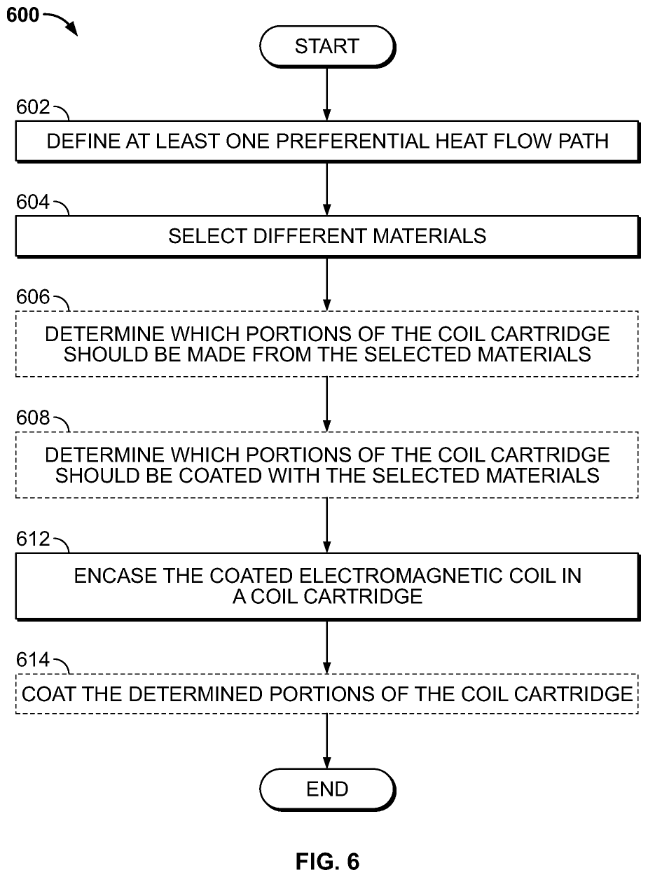

Each of the above-described techniques, either alone or in combination, also results in the encased electromagnetic coils 114 to exhibit an intentionally engineered heat flow path. An embodiment of a process 600 that implements both of these techniques is depicted in FIG. 6, and will now be described. It should be noted, however, that the described process 600 may be implemented without some of the described process steps. The process steps that are optional are illustrated with dotted line functional blocks. It should additionally be noted that, as with the description of FIG. 3, the heat generated in the electromagnetic coil 118 will be defined in advance using conventional thermal analysis and modeling, which is related to power density, length, number of turns, and material, and because the electromagnetic coil 118 exhibits relatively high thermal conductivity and thermal diffusivity, it is assumed that the temperature thereof will be uniform.

With the above in mind, and as FIG. 6 depicts, the process 600 begins by defining at least one preferential heat flow path for heat to flow for the electromagnetic coil 118 (602). A plurality of different materials, each having different heat flow properties, are then selected (604). If this portion of the process 600 is to be implemented, a determination is made as to which portions of the coil cartridge 122 should be made from at least some of the selected materials (606). If the additional portion of the process 600 is to be implemented, a determination is made as to which portions of the coil cartridge 122 should be coated with at least some of the selected materials (608). Whether one or both of the previous process steps are implemented, the electromagnetic coil 118 (which may or may not be coated per process 300) is then encased in the coil cartridge 122 (612) to produce an encased electromagnetic coil 114. Thereafter, if process step 608 was implemented, the determined portions of the insulating coil cartridge 122 are then coated with at least some of the different materials to make a coated insulating coil cartridge (614).

Whether used alone or in combination, it will be appreciated that the material selection techniques described herein may desirably result in the coil cartridge 114 exhibiting heat flow anisotropy. This allows the heat generated in the electromagnetic coil 118 to flow in an intentional and preferential direction without negatively impacting the properties of the electromagnetic coil and/or surrounding device components. As such, with appropriately selected materials, the electromagnetic coils 118 disclosed herein can be operated at extreme operating conditions (e.g., temperatures that range from −60° F. up to at least 950° F.) as compared to the operating condition limitations associated with conventional electromagnetic coils.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for manufacturing an electromagnetic coil with an intentionally engineered heat flow path, the method comprising the steps of:
defining at least one preferential heat flow path for heat to flow from the electromagnetic coil;
selecting a plurality of different materials, each of the different materials having different heat flow properties;
determining which portions of the electromagnetic coil should be coated with each of the different materials that will result in the at least one preferential heat flow path;
coating the determined portions of the electromagnetic coil with each of the different materials to make a coated electromagnetic coil; and
encasing the coated electromagnetic coil in a coil cartridge.

2. The method of claim 1, wherein at least one of the plurality of different materials has heat flow properties that vary at different rates with temperature.

3. The method of claim 1, wherein the plurality of different materials are selected and the determined portions of the electromagnetic coil are determined such that the at least one preferential heat flow path varies at one or more predetermined temperatures.

4. The method of claim 1, further comprising:
embedding at least portions of the coated electromagnetic coil with a material having a predetermined thermal conductivity and thermal diffusivity.

5. The method of claim 1, wherein the plurality of materials include one or more of zirconia, silicon nitride, nickel-molybdenum alloy, various steels, silicon carbide, silver, copper gold, aluminum, tungsten, platinum, iron, aluminum oxide, ceramic glass, fused quartz, various glasses, cements, silicates phosphates, magnesium oxide, zircon, various composites, and aerogels.

6. The method of claim 5, wherein the plurality of different materials comprise a fabric having one or more materials embedded therein.

7. The method of claim 1, wherein the thermal conductivity of each of the different materials is in the range of 0.01 W/m-K to 2000 W/m-K.

8. The method of claim 1, further comprising:
coating different portions of the coil cartridge with a plurality of different coating materials, each of the plurality of different coating materials having different heat flow properties.

9. The method of claim 1, wherein:
the coil cartridge comprises at least a first material having first heat flow properties and a second material having second heat flow properties; and
the first heat flow properties differ from the second heat flow properties.

10. A method for manufacturing an electromagnetic coil with an intentionally engineered heat flow path, the method comprising the steps of:
defining at least one preferential heat flow path for heat to flow from the electromagnetic coil;
selecting a plurality of different materials, wherein the plurality of different materials includes at least a first material having first heat flow properties and a second material having second heat flow properties that differ from the first heat flow properties;
determining which portions of a coil cartridge should be made from at least the first material and the second material that will result in the at least one preferential heat flow path; and
encasing the electromagnetic coil in the coil cartridge using at least the first and second materials.

11. The method of claim 10, further comprising:
coating different portions of the coil cartridge with at least some of the different coating materials.

12. The method of claim 10, wherein at least one of the plurality of different materials has heat flow properties that vary at different rates with temperature.

13. The method of claim 10, wherein the plurality of different materials are selected such that the at least one preferential heat flow path varies at one or more predetermined temperatures.

14. The method of claim 10, further comprising:
coating at least portions of electromagnetic coil with at least some of the different materials.

15. A method for manufacturing an electromagnetic coil with an intentionally engineered heat flow path, the method comprising the steps of:
defining at least one preferential heat flow path for heat to flow from the electromagnetic coil;
selecting a plurality of different materials, each of the different materials having different heat flow properties;
determining which portions of a coil cartridge should be coated with each of the different materials that will result in the at least one preferential heat flow path;
encasing the electromagnetic coil in the coil cartridge; and
coating the determined portions of the coil cartridge with at least some of the different materials.

16. The method of claim 15, wherein:
the coil cartridge comprises at least a first material having first heat flow properties and a second material having second heat flow properties; and
the first heat flow properties differ from the second heat flow properties.

17. The method of claim 16, wherein at least one of the plurality of different materials has heat flow properties that vary at different rates with temperature.

18. The method of claim 16, wherein the plurality of different materials are selected such that the at least one preferential heat flow path varies at one or more predetermined temperatures.

19. The method of claim 16, further comprising:
coating at least portions of electromagnetic coil with at least some of the different materials.
